(19) United States
(12) Patent Application Publication
(10) Pub. No.: US 2015/0175827 A1
(43) Pub. Date: Jun. 25, 2015

(54) POLYETHYLENE COMPOSITION FOR EXTRUSION COATING

(71) Applicant: NOVA Chemicals (International) S.A., Fribourg (CH)

(72) Inventors: Mehdi Keshtkar, Calgary (CA); Tieqi Li, Calgary (CA)

(73) Assignee: NOVA Chemicals (International) S.A., Fribourg (CH)

(21) Appl. No.: 14/556,500

(22) Filed: Dec. 1, 2014

(30) Foreign Application Priority Data
Dec. 19, 2013 (CA) 2837591

(51) Int. Cl. C09D 123/06; B05D 1/26

(52) U.S. Cl. CPC C09D 123/06; B05D 1/265

(57) ABSTRACT

A low density polyethylene (LDPE) made in a tubular reactor has improved stretch-ratio and melt strength properties after being blended with a small amount (1-25 weight percent of the blend) of a high density polyethylene (HDPE). The blends are useful as extrusion coating compositions.

### TECHNICAL FIELD

The current disclosure relates to polymer blend compositions that are useful as extrusion coating compositions. The polymer blends have a good balance of melt strength, neck-in index and stretch ratio. The current disclosure is also directed to an extrusion coating process using a polymer blend comprising a LDPE made in a tubular reactor and relatively small amounts of a high molecular weight, high density ethylene copolymer or homopolymer.

### BACKGROUND

To be useful in extrusion coating applications, ethylene polymers should have a balance of low neck-in, and high drawdown. High pressure low density polyethylene (HP-LDPE), which typically has a density range of from about 0.91 to about 0.94 g/cm³ and which is most commonly prepared by free radical polymerization in either a tubular reactor or an autoclave reactor, is often used for extrusion coating applications due to its good neck-in and drawdown rate properties.

Without wishing to be bound by theory, the following general differences between polyethylene made in an autoclave reactor and a polyethylene made in a tubular reactor are discussed. Due to the broad residence time distributions, polyethylene made in an autoclave reactor typically has a larger proportion of high molecular weight polymer and long chain branching relative to polyethylene made using a tubular reactor, where residence time distributions are comparably narrower. As a consequence, autoclave linear low density polyethylene (LDPE) generally has superior neck-in properties. In contrast, tubular reactors provide LDPE with good adhesion properties due in part to a higher proportion of low molecular weight polymer. Also, LDPE made in a tubular reactor, when compared to LDPE made in an autoclave reactor, most often has superior drawdown performance.

Since autoclave LDPE has superior neck-in properties, it is generally preferred over tubular LDPE when it comes to use in extrusion coating applications. Notwithstanding this fact, tubular LDPE is more readily available from commercial sources than autoclave LDPE and it would be advantageous to develop methods which make tubular LDPE resin behave more like autoclave LDPE with respect to performance in extrusion coating applications. For example, methods to improve the melt strength, and hence the neck-in properties of a tubular LDPE resin would be desirable.

In U.S. Pat. No. 4,496,698, a process is described in which ethylene is partially polymerized in an autoclave reactor, passed through a heat exchanger and then further polymerized in a tubular reactor. By using autoclave and tubular reactors in series, a low-density polyethylene with characteristics representative of each reactor type may be produced. The polyethylene resins so formed, which have a high drawdown and a low neck-in, are useful in extrusion coating applications.

Physical blends comprising both autoclave and tubular low density polyethylene resins are disclosed in Canadian Application No. 2,541,180 and European Patent No. 945,489.

Alternatively, high drawdown rates and good neck-in values can be achieved by co-extrusion of LDPE with linear low-density polyethylene (LLDPE). U.S. Pat. Nos. 5,863,665 and 5,582,923 disclose an extrusion polymer blend composed of 75 to 95 weight percent of an ethylene/α-olefin interpolymer having a density of from 0.85 to 0.940 g/cm³ and 5 to 25 weight percent of a high pressure, low density ethylene polymer, which is useful for application in extrusion coating processes.

U.S. Pat. No. 4,339,507 discloses a similar process for the extrusion coating of a substrate but with a polymer blend containing from greater than 20 to 98 wt % of a high pressure, low density polyethylene homopolymer or copolymer and from 2 to 80 wt % of a linear low density ethylene copolymer.

U.S. Pat. No. 3,247,290 discloses a polymer blend containing 5 to 20 wt % of a linear low density polyethylene and from 80 to 95 wt % of a thermally degraded high density polyethylene, which blend is useful for extrusion coating.

U.S. Pat. No. 3,375,303 teaches the use of a blend comprising a high molecular weight HDPE having a melt index I₂ of ≦0.1 g/10 min. and an LDPE having a melt index of no more than 30 times the melt index of the HDPE. Although up to 40 weight percent of HDPE is contemplated for use in the blends, the preferred range is from 1 to 9 weight percent with the balance being LDPE. The LDPE exemplified for use in the blends has a melt index, I₂ of below 1.0 g/10 min.

U.S. Pat. No. 3,231,636 disclosed a blend comprising from 50 to 85 parts by weight of a polyethylene resin having a density of above 0.945 g/cm³ and a melt index of from 0.02 to 8 g/10 min., with from 50 to 15 parts by weight of a polyethylene resin having a density of from 0.915 to 0.925 g/cm³ and a melt index of from 0.02 to 25 g/10 min. Thus, the blends comprise at least 50 weight percent of a HDPE component.

A similar blend is taught in U.S. Pat. No. 4,954,391. Again, the HDPE is present as the main component of the blend, present in at least 50% by weight, preferably, at least 70% by weight. The balance, by weight, of the blend may be a LLDPE or a LDPE.

U.S. Pat. No. 4,623,567 describes a blend of LDPE homopolymer with a polyethylene copolymer having a density of from 0.905 to 0.940 g/cm³. The LDPE has a melt index in the range of from 0.15 to 3 g/10 min. and is present at from 25 to 95 weight percent based on the weight of the blend.

U.S. Pat. No. 4,623,581 describes a similar blend but the LDPE has a melt index of from 0.3 to 2 g/10 min. and is present in an amount of from 2 to less than 25 weight percent based on the weight of the blend.

In U.S. Pat. No. 3,998,914 a high density film with improved clarity is taught. The film is made from a blend which employs a high density polyethylene as the base resin and up to 30 weight percent of a low density polyethylene which may be a LDPE made in a high pressure reactor.

U.S. Pat. No. 7,812,094 describes a polymer blend comprising a bimodal HDPE and an LDPE. Use of a bimodal HDPE in place of a unimodal HDPE provided a homogeneous resin blend with high drawdown rates. The bimodal HDPE component is made in a two stage polymerization process.

U.S. Pat. No. 5,338,589 discloses a molding composition consisting of 50 to 80% by weight of a HDPE having a broad, bimodal molecular weight distribution and from 20 to 50% by weight of a LDPE. The bimodal HPDE component is made in a two stage polymerization process.

WO 83/00490 discloses a polyethylene blend comprising form 90 to 10 weight percent of a HDPE and from 10 to 90 weight percent of a LDPE. The HDPE component has a density of from 0.960 to 0.980 g/cm³ and a melt index I₂ of from 5 to 18 g/10 min. The blend is used for extrusion coating.

U.S. Patent Application Publication No. 2008/0261064 describes a blend comprising a multimodal HDPE and an LDPE. The HDPE blend component has a melt index I₂ of higher than 5 g/10 min. The blend composition is applicable to extrusion coating processes and preferably comprises from 40 to 99% by weight of the multimodal HDPE and from 1 to 60% by weight of the LDPE.

U.S. Patent Application Publication No. 2010/0196641 is directed to a polyethylene foam based on a blend comprising 95.5 to 99.5 weight percent of a low density polyethylene and from 0.5 to 4.5 weight percent of a high density polyethylene. The polyethylene foam also comprises a nucleating agent.

U.S. Patent Application Publication No. 2012/0193266 teaches a composition for use in stretch blow molded articles such as thin wall containers. The composition is made from a polymer blend comprising at least 70 percent by weight of a high density polyethylene with from 10 to 30 percent by weight of a low density polyethylene. The blends have a higher melt strength and improved processability.

U.S. Pat. Nos. 6,545,094 and 6,723,793 each disclose a blend comprising A) a heterogeneous or homogeneous linear ethylene homopolymer or copolymer and B) a branched homopolymer or interpolymer. As component A, substantially linear low density polyethylene and high density polyethylene are exemplified. As component B, high pressure low density polyethylene is exemplified. The patent does not specifically disclose or teach the use of high density polyethylenes having a melt index I₂ of below 1 g/10 min. for use in the blends. In addition, the majority of the inventive examples comprising a HDPE and a LDPE, are blends having the high density polyethylene present as the majority species and in no case is the high density polyethylene present in less than 35% by weight.

A related blend is taught in U.S. Pat. No. 7,776,987. A resin suitable for extrusion coating comprises a mixture of a linear polyethylene having a melt index I₂ of greater than 20 g/10 min. and a low density branched polymer having a melt index I₂ which is preferably less than 2.0 g/10 min. and where the LDPE is present in the blend at no more than 30% by weight.

U.S. Patent Application Publication No. 2013/0017745 discloses extrusion coating compositions comprising up to 20 wt % of a LDPE (including LDPE which is produced in a tubular reactor) with the balance being a multimodal linear polyethylene having a melt index I₂ of from 5 to 15 g/10 min.

U.S. Patent Application Publication No. 2013/0123414 discloses that LDPE can be blended with a metallocene made linear low density polyethylene (mLLDPE) to improve the toughness of the autoclave LDPE without a large decrease in the neck-in values.

WO 92/17539 discloses a physical blend of two polymer components having a high molecular weight. The first component is a high molecular weight high density polyethylene (HMW-HDPE). The second component is a high molecular weight low density polyethylene (HMW-LDPE). An exemplified LDPE is Quantum USI's Petrothene LDPE NA 355 which has a fractional melt index (I₂=0.5 g/10 min.) consistent with a high molecular weight. The more preferred blends have 80 percent by weight of HDPE and 20 percent by weight of LDPE. The blends are used to make high clarity blown films.

U.S. Pat. No. 3,176,052 discusses blends containing a minimum of 25 wt % based on the weight of the blend of an ethylene copolymer having a density of at least 0.92 g/cm³ where the balance of the blend comprises a LDPE. The patent does not disclose that such blends are useful for application in extrusion coating compositions. Instead, the application is directed to blown film having improved optics and physical properties.

U.S. Pat. No. 2,983,704 claims homogeneous blends consisting of branched ethylene polymer (a LDPE) having a density of between 0.91 and 0.925 g/cm³ with a linear ethylene polymer having a density between 0.94 and 0.9757 g/cm³ where the blend has an overall density of between 0.9205 and 0.9454 g/cm³. The blends are used in polyethylene film applications including laminating products. There is no teaching that a LDPE resin made in a tubular reactor can be made to behave more like a LDPE resin made in an autoclave reactor by adding small amounts of high molecular weight HDPE. That is, there is no teaching that the use of a HDPE specifically having a melt index of below 1 g/10 min. is particularly useful in order to improve the neck-in properties of a LDPE made in a tubular reactor.

Due to the limitations in pressure, peak temperatures and residence times associated with the manufacture of LDPE in a tubular reactor process, making resins having a high molecular weight fraction, at low densities and high levels of long chain branching is a challenge. Hence, additional, simple blending methods by which to modify a LDPE made in a tubular reactor, so that it maintains its good drawdown performance while improving its melt strength and neck-in properties, would be useful.

### SUMMARY

The present disclosure provides a method for increasing the melt elasticity of LDPE made in a tubular reactor by using a blending strategy.

The present disclosure improves the performance of high pressure low density polyethylene (HP-LDPE) resin made in a tubular reactor by adding relatively small amounts of a high density, high molecular weight ethylene copolymer or homopolymer.

In an embodiment of this disclosure, a HP-LDPE made in a tubular reactor, when blended with about 5 to about 25 weight percent (based on the weight of the blend) of an HDPE resin having a melt index I₂ of less than 1 g/10 min. has an improved stretch ratio, as well as improved melt strength and neck-in index. These increases in melt strength and stretch ratio provide blends which when used as extrusion coating compositions are competitive to autoclave LDPE reins while at the same time maintaining or enhancing advantages typically associated with tubular LDPE resins.

The present disclosure provides polymer blends that have good neck-in index values at high stretch ratios.

The blends are useful as extrusion coating compositions or for use in extrusion coating processes.

Provided is an extrusion coating composition comprising about 95 to about 75 weight percent, based on the weight of the composition, of a high pressure, low density polyethylene produced in a tubular reactor and having a melt index I₂ of from 2 to 10 g/10 min.; and about 25 to about 5 weight percent, based on the weight of the composition, of a high density polyethylene having a melt index I₂ of from greater than 0.1 g/10 min. to less than 1 g/10 min.; wherein the extrusion coating composition has a density of from about 0.918 to about 0.932 g/cm³ and an entanglement density which is at least 10% higher than the entanglement density of the high pressure low density polyethylene produced in a tubular reactor.

In an embodiment, the extrusion coating composition comprises about 95 to about 75 weight percent, based on the weight of the composition, of a high pressure low density polyethylene produced in a tubular reactor which has a density of from 0.914 to 0.930 g/cm³.

In an embodiment, the extrusion coating composition comprises about 95 to about 75 weight percent, based on the weight of the composition, of a high pressure low density polyethylene produced in a tubular reactor which has a M_{w}/Mₙ of at least 8.0.

In an embodiment, the extrusion coating composition comprises about 95 to about 75 weight percent, based on the weight of the composition, of a high pressure low density polyethylene produced in a tubular reactor which has a melt index I₂ of from greater than 3 g/10 min. to 9 g/10 min.

In an embodiment, the extrusion coating composition comprises about 25 to about 5 weight percent, based on the weight of the composition, of a high density polyethylene which has a density of greater than 0.940 g/cm³ to 0.950 g/cm³.

In an embodiment, the extrusion coating composition comprises about 25 to about 5 weight percent, based on the weight of the composition, of a high density polyethylene which has a melt index I₂ of from greater than 0.1 g/10 min. to 0.7 g/10 min.

In an embodiment, the extrusion coating composition comprises about 25 to about 5 weight percent, based on the weight of the composition, of a high density polyethylene which has a melt index I₂ of from 0.2 to 0.5 g/10 min.

In an embodiment, the extrusion coating composition has a polydispersity index M_{w}/Mₙ of from about 6 to about 10.

In an embodiment, the extrusion coating composition has a density of from about 0.920 to about 0.932 g/cm³.

In an embodiment, the extrusion coating composition comprises about 25 to about 5 weight percent, based on the weight of the composition, of a high density polyethylene which is made with a Ziegler-Natta catalyst or a chromium catalyst in a single reactor.

In an embodiment, the extrusion coating composition comprises about 25 to about 5 weight percent, based on the weight of the composition, of a high density polyethylene which has a broad, unimodal profile when analyzed by gel permeation chromatography.

Provided is an extrusion coating process characterized in that said process comprises coating a substrate with a polymer blend comprising: about 95 to about 75 weight percent, based on the weight of the blend, of a high pressure low density polyethylene produced in a tubular reactor; and about 25 to about 5 weight percent, based on the weight of the blend, of a high density polyethylene having a melt index I₂ of less than 1 g/10 min; wherein the polymer blend has a density of from about 0.918 to about 0.932 g/cm³ and an entanglement density which is at least 10% higher than the entanglement density of the high pressure low density polyethylene produced in a tubular reactor.

### DETAILED DESCRIPTION OF EMBODIMENTS

Polymer blends of the current disclosure are usefully employed as extrusion coating compositions, and hence may be referred to as such.

LDPE is an “ethylene homopolymer” which is prepared by polymerizing ethylene monomer exclusively at high pressure conditions using free-radical polymerization methods as is well known in the art. As such, LDPE is also called HP-LDPE for high pressure linear low density polyethylene. One type of LDPE is produced in a tubular reactor (as opposed to an autoclave reactor) and may be designated herein as t-LDPE for tubular low density polyethylene or as t-HP-LDPE for tubular high pressure low density polyethylene. Optionally, the t-LDPE “ethylene homopolymers” produced in a tubular reactor may contain trivial amounts of another comonomer.

The polymer blends of the current disclosure are prepared by physically blending the t-LDPE with a high density polyethylene (HDPE).

Physically blending is meant to encompass those processes in which two or more individual ethylene polymers are mixed after they are removed from a polymerization reaction zone. Physically blending of individual ethylene polymers may be accomplished by dry blending (e.g. tumble blending), extrusion blending (co-extrusion), solution blending, melt blending or any other similar blending technique known to those skilled in the art.

The High Pressure Tubular Low Density Polyethylene (t-LDPE)

The t-LDPE used in the current disclosure is prepared by free radical polymerization of ethylene in a tubular reactor. A tubular reactor operates in a continuous mode and at high pressures and temperatures. Typical operating pressures for a tubular reactor are from about 2000 to about 3500 bar. Operating temperatures can range from about 140° C. to about 340° C. The reactor is designed to have a large length to diameter ratio (from about 400 to about 40,000) and may have multiple reaction zones, which take the shape of an elongated coil. High gas velocities (at least 10 m/s) are used to provide optimal heat transfer. Conversions for multi-zone systems are typically about 22 to about 30% per pass but can be as high as about 36 to about 40%. Tubular reactors may have multiple injection points for addition of monomer or initiators to different reaction zones having different temperatures. For methods of making t-LDPE in a tubular reactor see, for example, U.S. Pat. No. 3,691,145.

Although test procedures known in the art, such as gel permeation chromatography with viscometry detection (GPC-visc), capillary rheology and temperature rising elution fractionation (TREF) may help to distinguish between polyethylene made in a tubular reactor and polyethylene made in an autoclave reactor, in an embodiment of the present disclosure, the t-LDPE used in the polymer blends will be unequivocally identified by a commercial supplier as being made in a tubular reactor.

A wide variety of initiators may be used in a tubular reactor to initiate the free radical polymerization of ethylene. Suitable free radical initiators include those well known to persons skilled in the art and include peroxides, hydroperoxides, azo compounds, peresters and the like, and may include mixtures thereof. Initiators may include oxygen or one or more organic peroxides, such as, but not limited to, di-tert-butylperoxide, cumuyl peroxide, tert-butyl-peroxypivalate, tert-butyl hydroperoxide, benzoyl peroxide, tert-amyl peroxypivalate, tert-butyl-peroxy-2-ethylhexanoate, and decanoyl peroxide. Chain transfer reagents may also be used to control the polymer melt index (I₂). Chain transfer reagents include but are not limited to propane, n-butane, n-hexane, cyclohexane, propylene, 1-butene, and isobutylene.

In an embodiment of this disclosure, the t-LDPE produced in a tubular reactor has a density in the range of 0.910 to 0.940 g/cm³ as measured according to the procedure of ASTM D-792. In an embodiment of this disclosure, the t-LDPE produced in the tubular reactor has a density of 0.912 to 0.930 g/cm³ as measured according to the procedure of ASTM D-792. In another embodiment of this disclosure, the t-LDPE produced in the tubular reactor has a density of 0.914 to 0.930 g/cm³ as measured according to the procedure of ASTM D-792. In another embodiment of this disclosure, the t-LDPE produced in the tubular reactor has a density of 0.914 to 0.925 g/cm³ as measured according to the procedure of ASTM D-792. In further embodiments of this disclosure, the t-LDPE produced in the tubular reactor has a density of from 0.915 to 0.940 g/cm³, or from 0.915 to 0.932 g/cm³, or from 0.920 to 0.940 g/cm³, or from 0.920 to 0.932 g/cm³ as measured according to the procedure of ASTM D-792.

In embodiments of this disclosure, the t-LDPE produced in a tubular reactor has a melt index, I₂ in the range of from about 2 to about 10 g/10 min., or from about 3 to about 9 g/10 min., or from greater than 3 g/10 min. to about 9 g/10 min., as measured according to the procedure of ASTM D-1238 (at 190° C.) using a 2.16 kg weight.

Polydispersity, also known as molecular weight distribution (MWD), is defined as the weight average molecular weight, M_{w} divided by the number average molecular weight, Mₙ (i.e. M_{w}/Mₙ). In the present disclosure, polydispersity was determined by gel permeation chromatography (GPC)-viscometry. The GPC-viscometry technique was based on the method of ASTM D6474-99 and uses a dual refractometer/viscometer detector system to analyze polymer samples. This approach allows for the online determination of intrinsic viscosities and is well known to those skilled in the art.

In an embodiment of this disclosure, the t-LDPE has a polydispersity of greater than about 4.0, or greater than about 5.0. In further embodiments, the t-LDPE made in a tubular reactor will have a polydispersity of from about 3 to about 35, or from about 5 to about 30, or from about 8 to about 25, or from about 5 to about 25, or from about 6 to about 25, or from about 6 to about 20, or from about 6 to about 15, or from about 8 to about 15, or from about 8 to about 12, or from about 6 to about 12, or at least 6.0, or at least 7.0, or at least 8.0.

The molecular weight distribution of the t-LDPE produced in a tubular reactor can be further described as unimodal, bimodal or multimodal. By using the term “unimodal”, it is meant that the molecular weight distribution can be said to have only one maximum in a molecular weight distribution curve. A molecular weight distribution curve can be generated according to the method of ASTM D6474-99. By using the term “bimodal”, it is meant that the molecular weight distribution can be said to have two maxima in a molecular weight distribution curve. The term “multi-modal” denotes the presence of more than two maxima in such a curve. The t-LDPE used in the current disclosure may have unimodal, bimodal or multimodal molecular weight distributions. In an embodiment of the current disclosure, the t-LDPE produced in a tubular reactor has a multimodal molecular weight distribution. In an embodiment of the current disclosure, the t-LDPE has a broad unimodal distribution.

### The High Density Polyethylene (HDPE)

The high density polyethylene (HDPE) used in the current disclosure can be a homopolymer or a copolymer of ethylene; in some embodiments a copolymer is preferred. Suitable comonomers include alpha olefins, such as, but not limited to, 1-propylene, 1-butene, 1-pentene, 1-hexene and 1-octene. In some embodiments, the comonomers are 1-butene, and 1-hexene are preferred.

In an embodiment of this disclosure, the HDPE will have a density of from 0.935 to 0.970 g/cm³ as measured according to the procedure of ASTM D-792. In an embodiment of this disclosure, the HDPE will have a density of from 0.935 to 0.965 g/cm³ as measured according to the procedure of ASTM D-792. In an embodiment of this disclosure, the HDPE will have a density of from 0.939 to 0.962 g/cm³. In an embodiment of this disclosure, the HDPE will have a density of from 0.940 to 0.960 g/cm³. In an embodiment of this disclosure, the HDPE will have a density of from 0.940 to 0.955 g/cm³. In an embodiment of this disclosure, the HDPE will have a density of from greater than 0.940 g/cm³ to 0.952 g/cm³. In an embodiment of this disclosure, the HDPE will have a density of from 0.940 to 0.950 g/cm³. In an embodiment of this disclosure, the HDPE will have a density of from greater than 0.940 g/cm³ to 0.950 g/cm³.

In an embodiment of this disclosure, the HDPE has a melt index, I₂ of less than 1 g/10 min. as measured according to the procedure of ASTM D-1238 (at 190° C.) using a 2.16 kg weight. In an embodiment of this disclosure, the HDPE will have a melt index of from greater than 0.1 g/10.min. to less than 1 g/10 min. In an embodiment of this disclosure, the HDPE will have a melt index of from 0.1 to 0.9 g/10 min. In an embodiment of this disclosure, the HDPE will have a melt index of from greater than 0.1 g/10 min. to 0.9 g/10 min. In an embodiment of this disclosure, the HDPE will have a melt index of from greater than 0.1 g/10 min. to 0.7 g/10 min. In an embodiment of this disclosure, the HDPE will have a melt index of from 0.2 to 0.5 g/10 min. In an embodiment of this disclosure, the HDPE will have a melt index of from 0.25 to 0.45 g/10 min.

In embodiments of the current disclosure, the HDPE will have a polydispersity index (Mw/Mn) of from about 2 to about 40, including narrower ranges as well as specific numbers within this range. Hence, in further embodiments, the HPDE will have a polydispersity index (Mw/Mn) of from about 4 to about 35, or from about 5 to about 35, or from about 6 to about 35, or from about 6 to about 30, or from about 6 to about 25, or from about 2 to about 35, or from about 2 to about 30, or from about 2 to about 25, or from about 4 to about 30, or from about 4 to about 25, or from about 5 to about 30, or from about 6 to about 25, or from about 5 to about 20, or from about 6 to about 20, or from about 6 to about 15, or from about 2 to about 20, or from about 4 to about 20, or from about 2 to about 15, or from about 2 to about 12, or from about 4 to about 15, or from about 4 to about 12, or from about 6 to about 12.

The HDPE is preferably not cross linked (i.e., not irradiated or chemically treated in a manner which produces crosslinking which is well known in the art).

The HDPE used in the present disclosure can be made using any of the well-known catalysts capable of generating HDPE, such as chromium catalysts, Ziegler-Natta catalysts and so called “single site catalysts” such as but not limited to metallocene catalysts, constrained geometry catalysts, and phosphinimine catalysts. The HDPE can be made in a solution phase, a slurry phase or a gas phase, polymerization process employing a suitable reactor design for that purpose.

The term “chromium catalysts” describes olefin polymerization catalysts comprising a chromium species, such as silyl chromate, chromium oxide, or chromocene on a metal oxide support such as silica or alumina. Suitable cocatalysts for chromium catalysts, are well known in the art, and include for example, trialkylaluminum, alkylaluminoxane, dialkoxyalkylaluminum compounds and the like.

The chromium catalyst may be a chromium oxide (i.e., CrO₃) or any compound convertible to chromium oxide. For compounds convertible to chromium oxide see U.S. Pat. Nos. 2,825,721; 3,023,203; 3,622,251 and 4,011,382. Compounds convertible to chromium oxide include, for example, chromic acetyl acetone, chromic chloride, chromic nitrate, chromic acetate, chromic sulfate, ammonium chromate, ammonium dichromate, and other soluble chromium containing salts.

The chromium catalyst may be a silyl chromate catalyst. Silyl chromate catalysts are chromium catalysts which have at least one group of the formula:

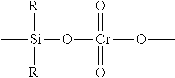

wherein R is independently a hydrocarbon group having from 1 to 14 carbon atoms.

In an embodiment of the current disclosure, the silyl chromate catalyst is a bis(silyl)chromate catalyst which has the formula:

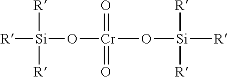

wherein R′ is independently a hydrocarbon group having from 1 to 14 carbon atoms.

R or R′ can independently be any type of hydrocarbyl group such as an alkyl, alkylaryl, arylalkyl or an aryl radical. Some non-limiting examples of R or R′ include methyl, ethyl, propyl, iso-propyl, n-butyl, iso-butyl, n-pentyl, iso-pentyl, t-pentyl, hexyl, 2-methyl-pentyl, heptyl, octyl, 2-ethylhexyl, nonyl, decyl, hendecyl, dodecyl, tridecyl, tetradecyl, benzyl, phenethyl, p-methyl-benzyl, phenyl, tolyl, xylyl, naphthyl, ethylphenyl, methylnaphthyl, dimethylnaphthyl, and the like.

Illustrative of preferred silyl chromates but by no means exhaustive or complete of those that can be employed in the present disclosure are such compounds as bis-trimethylsilylchromate, bis-triethylsilylchromate, bis-tributylsilylchromate, bis-triisopentylsilylchromate, bis-tri-2-ethylhexylsilylchromate, bis-tridecylsilylchromate, bis-tri(tetradecyl)silylchromate, bis-tribenzylsilylchromate, bis-triphenethylsilylchromate, bis-triphenylsilylchromate, bis-tritolylsilylchromate, bis-trixylylsilylchromate, bis-trinaphthylsilylchromate, bis-triethylphenylsilylchromate, bis-trimethylnaphthyl-silylchromate, polydiphenylsilylchromate, polydiethylsilylchromate and the like. Examples of bis-trihydrocarbylsilylchromate catalysts are also disclosed in U.S. Pat. Nos. 3,704,287 and 4,100,105.

The chromium catalyst may also be a mixture of chromium oxide and silyl chromate catalysts.

Although not preferred, the present disclosure also contemplates the use of chromocene catalysts (see, for example, U.S. Pat. Nos. 4,077,904 and 4,115,639) and chromyl chloride (e.g., CrO₂Cl₂) catalysts.

The term “Ziegler Natta catalyst” is well known to those skilled in the art and is used herein to convey its conventional meaning. Ziegler Natta catalysts comprise at least one transition metal compound of a transition metal selected from groups 3, 4, or 5 of the Periodic Table (using IUPAC nomenclature) and an organoaluminum component, which is defined by the formula:

Al(X′)ₐ(OR)_{b}(R)_{c}

wherein: X′ is a halide (preferably, chlorine); OR is an alkoxy or aryloxy group; R is a hydrocarbyl (preferably an alkyl having from 1 to 10 carbon atoms); and a, b, or c are each 0, 1, 2, or 3 with the provisos, a+b+c=3 and b+c≧1. As will be appreciated by those skilled in the art of ethylene polymerization, conventional Ziegler Natta catalysts may also incorporate additional components such as an electron donor. For example, an amine or an alcohol may be included. Also, Zielger Natta catalysts may further comprise a magnesium compound or a magnesium alkyl such as butyl ethyl magnesium and a halide source (which is typically a chloride, such as, tertiary butyl chloride), some combinations of which give rise to magnesium halides. Such components, if employed, may be added to the other catalyst components prior to introduction to the reactor or may be directly added to the reactor. The Ziegler Natta catalyst may also be “tempered” (i.e., heat treated) prior to being introduced to the reactor (again, using techniques which are well known to those skilled in the art and published in the literature).

Single site catalysts generally contain a transition element of Groups 3 to 10 of the Periodic Table and at least one supporting ligand. Some non-limiting examples of single site catalysts include metallocenes which contain two functional cyclopentadienyl ligands, constrained geometry catalysts which have a cyclopentadienyl ligand and an amido ligand (see, for example, U.S. Pat. Nos. 5,444,145 and 5,844,055) and posphinimine catalysts, which are catalysts having at least one phosphinimine ligand (see for example U.S. Pat. No. 6,777,509).

Single site catalysts are typically activated by suitable cocatalytic materials (i.e. “activators”) to perform the polymerization reaction. Suitable activators or cocatalytic materials are also well known to those skilled in the art. For example, suitable cocatalysts include but are not limited to electrophilic boron based activators and ionic activators, which are well known for use with metallocene catalysts, constrained geometry catalysts and phosphinimine catalysts (see for example, U.S. Pat. No. 5,198,401 and U.S. Pat. No. 5,132,380). Suitable activators including boron based activators are further described in U.S. Pat. No. 6,777,509. In addition to electrophilic boron activators and ionic activators, alkylaluminum, alkoxy/alkylaluminum, alkylaluminoxane, modified alkylaluminoxane compounds and the like can be added as cocatalytic components. Such components have been described previously in the art (see, for example, U.S. Pat. No. 6,777,509).

In an embodiment of this disclosure, the HDPE is made using a chromium catalyst in a single reactor.

In another embodiment of this disclosure, the HDPE is made using a Ziegler-Natta catalyst in a single reactor.

In another embodiment of this disclosure, the HDPE is made using a Ziegler-Natta or a chromium catalyst in a single reactor.

In an embodiment of this disclosure, the HDPE may comprise substantially a single polymer made in a single reactor, with a single catalyst type.

Alternatively, the HDPE may comprise two or more polymer components which may, for example, differ substantially in weight average molecular weight and/or comonomer content. Such polymers can be made by, for example, using similar catalysts in two or more reactors operating under different conditions, using dissimilar catalysts in a single reactor, or using dissimilar catalysts in two or more reactors. Where the HDPE comprises two polymer components having substantially different weight average molecular weights, a gel permeation chromatogragh may show two distinct areas, as opposed to a single broad area. Such a resin may be called bimodal (two distinct components) or multimodal (more than two distinct components), as opposed to monomodal or unimodal (one distinct area).

In an embodiment of the current disclosure, the HDPE will have a unimodal profile in a gel permeation chromatograph. In an embodiment of this disclosure, the HDPE will have a broad unimodal profile in a gel permeation chromatograph.

In an embodiment of this disclosure, the HDPE is made with a single catalyst type in a single polymerization reactor.

In an embodiment of this disclosure, the HDPE is made with a Ziegler-Natta catalyst in a solution phase polymerization reactor.

In an embodiment of this disclosure, the HDPE is made with a Ziegler-Natta catalyst in a gas phase polymerization reactor.

In an embodiment of this disclosure, the HDPE is made with a chromium catalyst in a gas-phase polymerization reactor.

In an embodiment of this disclosure, the HDPE is made with a chromium catalyst in a slurry-phase polymerization reactor.

### The Polymer Blend Compositions

In an embodiment of the current disclosure, the polymer blend described herein is an extrusion coating composition.

In an embodiment of this disclosure, the polymer blend described herein is used in an extrusion coating process.

In an embodiment of this disclosure, the polymer blend comprises about 99 to about 75 weight percent, based on the total weight of the blend, of a low density polyethylene (LDPE) that is produced in a tubular reactor and about 25 to about 1 weight percent, based on the weight of the blend, of a high density polyethylene (HDPE). In an embodiment of this disclosure, the polymer blend comprises about 99 to about 70 weight percent, based on the total weight of the blend, of a low density polyethylene (LDPE) that is produced in a tubular reactor and about 30 to about 1 weight percent, based on the weight of the blend, of a high density polyethylene (HDPE). In an embodiment of this disclosure, the polymer blend comprises about 95 to about 75 weight percent, based on the total weight of the blend, of a low density polyethylene (LDPE) that is produced in a tubular reactor and about 25 to about 5 weight percent, based on the weight of the blend, of a high density polyethylene (HDPE).

In further embodiments of the current disclosure, the polymer blend comprises about 95 to about 76 weight percent, based on the weight of the blend, of a low density polyethylene (LDPE) that is produced in a tubular reactor and about 24 to about 5 weight percent, based on the weight of the blend, of a high density polyethylene (HDPE); or comprises about 95 to about 80 weight percent, based on the weight of the blend, of a low density polyethylene (LDPE) that is produced in a tubular reactor and about 20 to about 5 weight percent, based on the weight of the blend, of a high density polyethylene (HDPE); or comprises about 95 to about 85 weight percent, based on the weight of the blend, of a low density polyethylene (LDPE) that is produced in a tubular reactor and about 15 to about 5 weight percent, based on the weight of the blend, of a high density polyethylene (HDPE); or comprises about 90 to about 80 weight percent, based on the weight of the blend, of a low density polyethylene (LDPE) that is produced in a tubular reactor and about 20 to about 10 weight percent, based on the weight of the blend, of a high density polyethylene (HDPE).

In embodiments of the current disclosure, the polymer blend will have a density of from about 0.910 to about 0.960 g/cm³, or from about 0.910 to about 0.955 g/cm³, or from about 0.915 to about 0.955 g/cm³, or from about 0.915 to about 0.950 g/cm³, or from about 0.910 to about 0.945 g/cm³, or from about 0.915 to about 0.940 g/cm³, or from about 0.915 to about 0.935 g/cm³, or from about 0.915 to about 0.932 g/cm³, or from about 0.918 to about 0.940 g/cm³, or from about 0.918 to about 0.935 g/cm³, or from about 0.918 to about 0.932 g/cm³, or from about 0.920 to about 0.955 g/cm³, or from about 0.920 to about 0.950 g/cm³, or from about 0.920 to about 0.945 g/cm³, or from about 0.920 to about 0.940 g/cm³, or from about 0.920 to about 0.935 g/cm³, or from about 0.920 to about 0.932 g/cm³, or from about 0.917 to about 0.945 g/cm³, or from about 0.917 to about 0.940 g/cm³, or from about 0.917 to about 0.935 g/cm³, or from about 0.917 to about 0.932 g/cm³.

In an embodiment of the current disclosure, the polymer blend will have a melt index I₂ of between about 0.1 g/10 min. and about 10 g/10 min. In further embodiments of this disclosure, the melt index I₂ of the blend will be from about 0.5 to about 9.5 g/10 min., or from about 0.5 to about 8.0 g/10 min., or from about 0.75 to about 6 g/10 min., or from about 0.75 to about 5 g/10 min., or from about 1.0 to about 5 g/10 min., or from about 1.0 to about 4.0 g/10 min., or from about 0.75 to about 3.5 g/10 min., or from about 1.0 to about 3.5 g/10 min., or from about 1.25 to about 3.5 g/10 min.

In embodiments of the current disclosure, the polymer blend will have a polydispersity index (Mw/Mn) of from about 2 to about 40, including narrower ranges as well as specific numbers within this range. Hence, in further embodiments of this disclosure, the HPDE will have a polydispersity index (Mw/Mn) of from about 4 to about 35, or from about 5 to about 35, or from about 6 to about 35, or from about 4 to about 30, or from about 6 to about 30, or from about 2 to about 35, or from about 2 to about 30 or from about 2 to about 25, or from about 5 to about 30, or from about 4 to about 25, or from about 5 to about 25, or from about 6 to about 25, or from about 5 to about 20, or from about 6 to about 20, or from about 6 to about 15, or from about 2 to about 20, or from about 4 to about 20, or from about 5 to about 20, or from about 5 to about 15, or from about 2 to about 15, or from about 2 to about 12, or from about 4 to about 15, or from about 4 to about 12, or from about 5 to about 12, or from about 6 to about 12, or from about 6 to about 10.

The polymer blends of the present disclosure are well suited for use as extrusion coating compositions or in extrusion coating processes. The extrusion coating process as contemplated by the current disclosure is a means to coat a substrate with a layer of polymer blend extrudate. The substrate is not limited in the present disclosure, but by way of non-limiting example, the substrate may include articles made of paper, cardboard, foil or other similar materials that are known in the art. The processes of extrusion blending (co-extrusion) and extrusion coating can be combined for the purposes of the current disclosure.

In an embodiment of this disclosure, the tubular LDPE, the HDPE or blends thereof may also contain additives which can contribute to the physical properties of the extrusion coating composition. Examples of additives include, and without limitation, antiblocking agents, antistatic agents, antioxidants, stabilizers, slip additives, ultra-violet protecting elements, oxidants, pigments and colouring agents, fire retardants, dyes, and fillers. The additives just mentioned can be used alone or in combination with one another.

Antioxidant packages for stabilizing polyolefins are well known in the art and commonly include a phenolic and a phosphite compound. Two non-limiting examples of a phenolic and phosphite stabilizer are sold under the trade names IRGANOX 1076 and IRGAFOS 168, respectively. The phenolic compound is sometimes referred to as the “primary” antioxidant. The phosphite compound is sometimes referred to as the “secondary” antioxidant. A general overview of phenol/phosphite stabilizers may be found in Polyolefins 2001—The International Conference on Polyolefins, “Impact of Stabilization Additives on the Controlled Degradation of Polypropylene”, p. 521.

In an embodiment of the current disclosure, the t-LDPE produced in the tubular reactor contains no or very low levels of a primary antioxidant.

In embodiments of the current disclosure, low levels of antioxidant provide the unexpected additional benefit of improving neck-in and adhesion characteristics of the ethylene homopolymer produced in the tubular reactor.

In embodiments of the present disclosure, the level of antioxidant in the blend or the blend components are from 0 to about 1000 parts per million (ppm), or from 0 to about 500 ppm, or from 0 to about 300 ppm.

The melt strength measured for the blends of the present disclosure is used as a relative predictor of relative neck-in value. That is, for a given set of polymer blend components, a polymer blend component or polymer blend having a melt strength value larger than another polymer blend component or polymer blend, would have a correspondingly lower neck-in value and vice versa.

In an embodiment of the current disclosure, the (“accelerated haul off”, see below) melt strength of the polymer blend will be at least 5% higher than the melt strength of the t-LDPE component used in the blend. In a further embodiment of this disclosure, the melt strength of the polymer blend will be at least 5% higher than the expected melt strength based on the weight fraction of each of the t-LDPE and HDPE components present in the blend. The expected value can be estimated by the so called “Rule of Mixing”. Briefly, the Rule of Mixing is followed where a blend property is approximately what a person skilled in the art would expect based on the weighted average of the blend components. The “Rule of Mixing” indicates a positive synergistic effect on a property in the blend where a blend property is better than expected based on the weighted average of the blend components. In contrast, a negative synergism is indicated where a blend property is worse than expected based on the weighted average of the blend components.

In further embodiments of the present disclosure, the melt strength of the polymer blend will be at least 10% higher, or at least 15% higher, or at least 20% higher, or at least 25% higher, or at least 30% higher, or at least 35% higher, or at least 40% higher, or at least 50% higher than the expected melt strength of the blend based on the weight fraction of each of the t-LDPE and HDPE components present in the blend.

The “neck-in index” calculated for the blends in the present disclosure is used as another relative predictor of relative neck-in value. That is, for a given set of polymer blend components, a polymer blend component or polymer blend having a neck-in index value smaller than another polymer blend component or polymer blend, would have a correspondingly lower neck-in value and vice versa.

Typically, an actual neck-in value is defined as one-half of the difference between the width of the polymer at the die opening and the width of the polymer at the take-off position during extrusion coating. The “take off position” is defined as the point at which the molten polymer contacts the substrate on the chill roll. Neck-in values may be reported for extrusion coatings obtained according to different extrusion coating line speeds as measured in feet per minute. The term “line speed” is the rate at which a polymer extrudate is coated on a substrate and is measured in feet per minute. It will be recognized by one skilled in the art that the measured neck-in values may vary for blends of a given drawdown rate due to minor differences in the testing equipment used, the extrusion coating line speeds, the operator procedures and the differences between polymer batches.

In an embodiment of the present disclosure, the polymer blend has an improved neck-in value when compared to a t-LDPE component used in the blend.

In an embodiment of this disclosure, the calculated neck-in index value of the polymer blend will be at least 10% lower than the neck-in index of the t-LDPE component used in the blend.

In further embodiments of this disclosure, the calculated neck-in index values of the polymer blend will be at least 15% lower, or at least 25% lower, or at least 35% lower, or at least 45% lower, or at least 55% lower, or at least 65% lower, or at least 75% lower, or at least 85% lower than the neck-in index of the t-LDPE component used in the blend.

The stretch ratio in the present disclosure is used as a relative predictor of relative draw down rate. That is, for a given set of polymer blend components, a polymer blend component or polymer blend having a stretch ratio value greater than another polymer blend component or polymer blend, would have a correspondingly higher drawdown rate and vice versa.

An actual drawdown rate is determined as the maximum line speed, during an extrusion coating process, typically in ft/min (although other units may also be used), at which the polymer melt breaks. Hence, the terms “drawdown” or “drawdown rate” are defined as the maximum line speed during extrusion (e.g., an extrusion coating process) and is a measure of how fast a polymer can be coated on a substrate.

In an embodiment of the current disclosure, the (“accelerated haul off”, see below) stretch ratio of the polymer blend will be at least 20% higher than the accelerated haul off stretch ratio of the t-LDPE component used in the blend.

In another embodiment of this disclosure, the haul off stretch ratio of the polymer blend will be at least 10% higher than the expected haul off stretch ratio based on the weight fraction of each of the t-LDPE and HDPE components present in the blend.

In further embodiments of this disclosure, the haul off stretch ratio of the polymer blend will be at least 15% higher, or at least 20% higher, or at least 25% higher, or at least 30% higher, or at least 35% higher, or at least 40% higher, or at least 45% higher than the expected haul off stretch ratio based on the weight fraction of each of the t-LDPE and HDPE components present in the blend.

The entanglement density is defined herein as Mw/Me, where Mw is the weight average molecular weight of a polymer blend or polymer blend component, and Me is the entanglement molecular weight of a polymer blend or a polymer blend component (for the determination of Me, see the examples section below).

In an embodiment of the current disclosure, the entanglement density of the polymer blend will be at least 10% higher than the entanglement density of the t-LDPE component used in the blend.

### Extrusion Coating Process

In an embodiment of the present disclosure, an extrusion coating process is characterized in that said process comprises coating a substrate with the polymer blend described herein.

In an embodiment of this disclosure, an extrusion coating composition is the polymer blend described herein.

In an embodiment of this disclosure, an extrusion coating composition comprises the polymer blend described herein.

Physical blends of a tubular t-LDPE and a HDPE can be prepared by melt blending pellets of each resin at the desired concentrations then coating the mixture on a substrate such as for example kraft paper using for example a 1.5 inch MPM extrusion coating line. The extrusion coating line may be equipped with: a screw (e.g., standard 1.5 inch diameter screw), a barrel and barrel heater (e.g., air cooled barrel with three 600 watt heating zones), a pressure indicator (e.g., Dynisco 0 psi to 5000 psi indicator), a die plate (e.g., a die plate with a 20 mesh screen pack), a drive (e.g., a 10 horsepower General Electric drive capable of producing a minimum output of 50 lb/hr polyethylene), an adaptor, and a die (e.g., a twelve inch slit Flex LD-40 die with a 0.20 inch die gap and three heating zones totaling 7000 Watts) and a laminator/coater. The adaptor may be equipped with the following: heaters and controllers (e.g., nine heater bands with a total of 4450 Watts), a thermocouple (e.g., a melt thermocouple located near the outlet of the adaptor and extending into the resin channel to measure molten polymer temperature) and a valve located in the front end of the adaptor to adjust barrel pressure. The laminator/coater may consist of: main rolls (e.g., 15 inch×15 inch chilled chrome roller and rubber coated chilled pressure roll), a drive (e.g., 10 horsepower DC General Electric drive capable of producing chill roll speeds from 0 ft/min to 2000 ft/min), a paper roll (e.g., equipped with a pneumatic brake system adjustable with a pressure regulator), a wind up unit (e.g., speed control via a magnetic clutch system) and a speed indicator (e.g., capable of measuring coating line speeds to 5000 ft/min).

The current disclosure is further described by the following non-limiting examples.

### Examples

### General

Polymer blend and polymer blend component densities were measured according to the procedure of ASTM D-792.

The melt index, I₂ was measured according to the procedure of ASTM D-1238 (at 190° C.) using a 2.16 kg weight.

Molecular weight information (M_{w}, and Mₙ in g/mol) and molecular weight distribution (M_{w}/Mₙ), were analyzed by gel permeation chromatography, using an instrument sold under the trade name “Waters 150c”. For GPC (Gel Permeation Chromatography), polymer sample solutions (about 2 mg/mL) were prepared by heating the polymer in 1,2,4-trichlorobenzene (TCB) and rotating on a wheel for 4 hours at 150° C. in an oven. The antioxidant 2,6-di-tert-butyl-4-methylphenol (BHT) was added to the mixture in order to stabilize the polymer against oxidative degradation. The BHT concentration was 250 ppm. Sample solutions were chromatographed at 140° C. on a PL 220 high-temperature chromatography unit equipped with four Shodex columns (HT803, HT804, HT805 and HT806) using TCB as the mobile phase with a flow rate of 1.0 mL/minute, with a differential refractive index (DRI) detector to measure the concentration and a viscometer to measure the viscosity. BHT was added to the mobile phase at a concentration of 250 ppm to protect SEC columns from oxidative degradation. The sample injection volume was 200 mL. The SEC raw data were processed using the universal calibration approach with the Cirrus GPC Multi software. The columns were calibrated with narrow distribution polystyrene standards. The polystyrene molecular weights were converted to polyethylene molecular weights using the Mark-Houwink equation, as described in the ASTM standard test method D6474.

Melt strength was measured using Rosand Capillary Rheometer (RH-7) with a flat entry die of L/D=10 and D=2 mm. The piston speed: 5.33 mm/min, pulley speed: 2.5 mm/min, time increment: 18.5 min, temperature=190° C. Pressure Transducer: 10,000 psi (68.95 MPa). Haul-off Angle: 52°. Haul-off incremental speed: 50 to 80 m/min² or 65±15 m/min². The polymer melt was extruded at a constant rate from a barrel through a standard die, and the extrudate is pulled via a pulley with increasing speed at a step increment of 10 s interval. The plateau force, or the final drawing force in the plateau region of a force versus time curve was taken as a measurement of (accelerated haul off) “melt strength”. The (accelerated haul off) “stretch ratio” (drawability) is the ratio of the velocity of pulley to the velocity of extrudate at die exit when the melt strand ruptured.

Dynamic Mechanical Analysis (DMA). Rheological measurements (e.g., small-strain (10%) oscillatory shear measurements) were carried out on a dynamic Rheometrics SR5 Stress rotational rheometer with 25 mm diameter parallel plates in a frequency sweep mode under full nitrogen blanketing. The polymer samples are appropriately stabilized with the anti-oxidant additives and then inserted into the test fixture for at least one minute preheating to ensure the normal force decreasing back to zero. All DMA experiments are conducted at 10% strain, 0.05 to 100 rad/s and 190° C. Orchestrator Software is used to determine the viscoelastic parameters including the storage modulus (G′), loss modulus (G″), complex modulus (G*) and complex viscosity (η*).

### Determination of the Neck-in Index

The “Neck-in index” value for each blend was not actually measured, but was calculated from experimentally determined PDI and melt strength values, numbers which are known to correlate to the neck-in value. The neck-in index is defined as: Neck-in index=Neck-in (mm)/die width (mm).

Based on actual measurements of tubular and autoclave LDPE resin using an extrusion coating line at a line speed of 200 ft/min, a correlation was developed between neck-in index, the polydispersity index (i.e., PDI=M_{w}/Mₙ), and the melt strength (accelerated haul-off at 190° C.) as: Neck-in index=0.363−0.0066 PDI−0.0266 MS, where PDI is the polydispersity index (Mw/Mn) and MS is the accelerated haul off melt strength. The data used to develop this correlation are provided in Table 1. The resins from which the correlation was determined included Resins A, B and C which are LDPE resins which were made in a high pressure tubular reactor; as well as Resins D, E, F which are LDPE resins made in a high pressure autoclave reactor and which are available from commercial sources.

TABLE 1

| | | | | AHO Melt | |
|---|---|---|---|---|---|
| | | Melt | | Strength | Measured |
| | Density | Index (I₂) | | @ 190° C. | Neck-In |
| Resin | (g/cm³) | (g/10 min) | PDI | (cN) | Index |
| Resin A | 0.920 | 4.2 | 7.79 | 5.23 | 0.1608 |
| tubular-LDPE | | | | | |
| Resin B | 0.916 | 7.2 | 12.86 | 4.26 | 0.1804 |
| tubular-LDPE | | | | | |
| Resin C | 0.916 | 4.6 | 9.43 | 6.72 | 0.1247 |
| tubular-LDPE | | | | | |
| Resin D | 0.917 | 6.8 | 19.8 | 6.59 | 0.0656 |
| autoclave-LDPE | | | | | |
| Resin E | 0.918 | 6.6 | 22.22 | 5.21 | 0.0689 |
| autoclave-LDPE | | | | | |
| Resin F | 0.924 | 4.2 | 12.84 | 6.72 | 0.0984 |
| autoclave-LDPE | | | | | |

### Determination of Entanglement Density

The melt of linear and substantially linear polymer is entangled when molecular weight is higher than a critical value, where zero-shear viscosity begins to scale to an exponent typically of 3 or higher. In one of the more modern molecular dynamic theories, e.g., Tube Theory by Doi and Edwards, the molecular weight between the neighboring entanglement points is the portion of the molecule that bears the same mean-square end-to-end length as the entire polymer (see: Larson, R. G., Sridhar, T., Leal, L. G., McKinley, G. H., Likhtman, A. E. and McLeish, T. C. B., “Definitions of Entanglement Spacing and Time Constants in the Tube Model”, J. Rheol., 47(3), (2003), pp. 809-818). The number of such segments, Z, can be considered as a measure of density of the entanglement for the ideal monodisperse polymer.

For the real polydisperse polymers of the interest of the current work, the entanglement density is hence defined as the ratio of the weight average molecular weight M_{w} over the molecular weight between entanglements Mₑ, where Mₑ is calculated from plateau modulus G⁰_{N} according to the following formula (where p is polymer density, R is the universal gas constant and T is temperature):

Mₑ=(4/5)ρRT/G⁰_{N}

The quantity M_{w}/Mₑ, herein defined as the “entanglement density”, numerically equals the number of segments Z of tube theory, by assuming the melt can be represented as a monodisperse polymer with the molecular weight equals to M_{w}.

The plateau modulus was determined from 190° C. frequency sweep data collected with a Rheometrics Dynamic Spectrometer (RDS-II) (φ25 mm cone/plate fixture) using 10% strain over frequency of 100 to 0.05 rad/sec at 190° C. The loss and storage moduli G″ (ω) and G′ (ω), respectively, were obtained at each frequency ω. The frequency sweep data are converted to a 33-point discrete relaxation spectrum with 0.6 decade relaxation time intervals as briefly introduced in the following paragraphs. The plateau modulus G⁰_{N} is then calculated as the sum of the relaxation strength gᵢ(τᵢ) of all 33-point relaxation modes.

To calculate the relaxation spectrum from the frequency sweep data the following equations are used:

$${G}^{′} = {\sum }_{i = 1}^{N} {g}_{i} \frac{{( {ωτ}_{i} )}^{2}}{1 + {( {ωτ}_{i} )}^{2}}$$

$${G}^{″} = {\sum }_{i = 1}^{N} {g}_{i} \frac{{ωτ}_{i}}{1 + {( {ωτ}_{i} )}^{2}}$$

where the function gᵢ(τᵢ) is assumed to be a summation of two second-order log-polynomials following the general principles established by Winter et al. (see: M. Baumgaertel, A Schausberger, and H. H. Winter, 1990, Rheol. Acta vol 29, pp 400-408; as well as J. K. Jackson, C. Garcia-Franco, and H. H. Winter, Proc. ANTEC 1992. pp 2438-2442). The polynomial kernels are assumed to be global on entire frequency range to obtain reproducible relaxation spectrum for polyethylene resins with which the experimentally accessible frequency range is narrow (see: T. Li, W. Lin and J. Teh, Reproducible Relaxation Spectrum of Polyethylene via Global Log-Polynomial Kernel. Submitted for presentation at ANTEC 2014). Specifically, the parameters Aⱼ, Bⱼ and Cⱼ (j=1 or 2) in the following equations are solved by minimizing the difference between the calculated and measured G*(ω):

log gₖ(τₖ)|₁=A₁+B₁ log τₖ+C₁(log τₖ)²

log gₖ(τₖ)|₂=A₂+B₂ log τₖ+C₂(log τₖ)²

The plateau modulus thus calculated is the extrapolated rubbery modulus of the polyethylene resins. It can be understood as the “rigidity” of the extrapolated rubbery state, where frequency would be so high or time is so short that elasticity dominates the response of the resin of interest. The plateau modulus value thus calculated therefor reveals the length of chains between entanglements through the equation: Mₑ=(4/5)ρ RT/G⁰_{N}. The ratio M_{w}/Mₑ then can be taken as the measure of the entanglement density.

### Blend Components

The resins used in the blends were resins A, G and H as shown in Table 2. Resin A is a t-LDPE which was made in a high pressure tubular reactor. Resin G is a HDPE which was made with a chromium catalyst in a gas phase reactor. Resin H is a HDPE which was made with a Ziegler-Natta catalyst in a solution polymerization process.

TABLE 2

| | Resin | | |
|---|---|---|---|
| | A | G | H |
| Density (g/cm³) | 0.92 | 0.949 | 0.942 |
| Melt index, I₂ | 4.5 | 0.4 | 0.33 |
| (g/10 min.) | | | |
| Mn | 18976 | 154 | 21850 |
| | | 59 | |
| Mw | 160134 | 147165 | 157154 |
| Mz | 522739 | 636482 | 541741 |
| Mw/Mn | 8.44 | 9.52 | 7.19 |
| Melt strength (cN) | 6.37 | 9.93 | 8.12 |
| Stretch Ratio | 142.5 | 196.5 | 227.8 |
| Measured Neck-in | 0.1608 | not applicable | not applicable |
| Index | | | |
| Relaxation Time (s) | 0.0566 | 0.556 | 0.0789 |
| Entanglement | 6.77 | 1.7 | 1.24 |
| molecular weight, Me | | | |
| (thousand) | | | |
| Entanglement Density | 23.67 | 86.8 | 126.1 |
| (Mw/Me) | | | |

### Inventive Blends

Physical blends of a tubular LDPE and a HDPE were prepared using a fusion-head mixer (manufactured by C. W. Brabender Instruments, Inc.) equipped with roller mixing blades in a mixing bowl having a 40 cm³ capacity. The blend components were mixed in the fusion-head mixer for a period of 10 minutes at 145° C.

The blends are useful as extrusion coating compositions. The data for blends made in the current disclosure are provided in Table 3.

TABLE 3

| | Blend Example No. | | | |
|---|---|---|---|---|
| | 1 | 2 | 3 | 4 |
| Composition | 90 wt % A + | 80 wt % A + | 90 wt % A + | 80 wt % A + |
| (based on the | 10 wt % G | 20 wt % G | 10 wt % H | 20 wt % H |
| weight of the | | | | |
| blend) | | | | |
| Density | 0.922 | 0.9254 | 0.9218 | 0.9245 |
| (g/cm³) | | | | |
| Melt Index, I₂ | 2.83 | 2.08 | 2.52 | 1.58 |
| (g/10 min) | | | | |
| Mn | 20788 | 17821 | 22768 | 18958 |
| Mw | 150986 | 160953 | 153479 | 167157 |
| Mz | 464284 | 636834 | 476707 | 642056 |
| Mw/Mn | 7.26 | 9.03 | 6.74 | 8.82 |
| Melt strength | 7.55 | 9.19 | 8.77 | 10.89 |
| (cN) | | | | |
| Stretch Ratio | 227.5 | 277.5 | 199.8 | 236.5 |
| Calculated | 0.1143 | 0.0588 | 0.0852 | 0.016 |
| Neck-in Index | | | | |
| Relaxation | 0.084 | 0.104 | 0.0651 | 0.0971 |
| Time (s) | | | | |
| Entanglement | 5.51 | 4.19 | 4.25 | 4.07 |
| molecular | | | | |
| weight, Me | | | | |
| (thousand) | | | | |
| Entanglement | 27.39 | 38.43 | 36.08 | 41.03 |
| Density | | | | |
| (Mw/Me) | | | | |

A person skilled in the art will recognize from the data provided in Table 3, that for all the blends (Examples 1-4), the resulting melt strength is higher than that expected if the rule of mixing were applied. Hence, there is a synergistic enhancement in the melt strength value for each of the blends in Table 3. For example, a blend having 90 weight % of A with 10 weight % of G, based on the weight of the blend, has a melt strength of 7.55 centiNewtons (cN), which is more than 10 percent higher than expected (note: the expected value would be 6.72), if the blends showed a weighted average of the melt strengths of the blended components. Similarly, synergistic effects are observed for blend Examples numbers 2, 3 and 4, which have melt strength values which are more than 20, 25 and 50 percent higher, respectively, than that expected from the weighted average of the blend components. As the melt strength is expected to be proportional to the blend neck-in value (the higher the melt strength, the smaller the amount of neck-in which will occur during extrusion coating), the blends should have better neck-in properties, than the tubular LDPE has on its own, hence making it more autoclave like with respect to neck-in during use in extrusion coating applications. Indeed, the data shows that the calculated neck-in index values (used herein as a proxy for actual neck-in), are at least 10% lower for the blends, than that measured for the high pressure low density polyethylene produced in a tubular reactor and used in the blends (for more on neck-in index, see below).

In addition to the melt strength, a person skilled in the art will recognize from the data given in Table 3 that the stretch ratio values for the blends are greater than those expected from the weighted average of the blend components. For example, a blend having 90 weight % of A with 10 weight % of G, based on the weight of the blend, has a stretch ratio of 227.5, which is more than 45 percent higher than expected (note: the expected value would be 147.9), if the blends showed a weighted average of the stretch ratios of the blended components. Similarly, for blend Examples numbers 2, 3 and 4, which have stretch ratios which are more than 40, 25 and 40 percent higher respectively than those expected from the weighted average of the blend components. As the stretch ratio is expected to be proportional to the drawdown rate (the higher the stretch ratio, the greater the drawdown rate one can use during extrusion coating), the blends should have maintained or improved drawdown rates, relative to those observed for tubular LDPE resin alone, another key property for extrusion coating performance. Indeed, the data shows that the stretch ratio (used herein as a proxy drawdown rate), are at least 10% higher for the blends, than that found for the high pressure low density polyethylene produced in a tubular reactor.

The above trends do not follow consistently when one examines the values for the entanglement density. For blends 1 and 4, the entanglement density is slightly lower than the expected weighted average of the components. Nevertheless, for blends 2 and 3, the entanglement density is slightly higher than the expected weighted average of the blend components. Hence, in terms of entanglement density, the blends approximately follow the rule of mixing.

In addition, for all of Examples 1-4, the entanglement density is at least 10% higher than the entanglement density of the t-LDPE.

Table 4 shows the calculated neck-in index for the blends of the current disclosure, as compared to experimental determined neck-in index data obtained for various LDPE materials made in either a tubular reactor or an autoclave reactor.

TABLE 4

| Resin | Neck-In Index |
|---|---|
| Resin A, tubular-LDPE | 0.1608 (measured) |
| Resin B, tubular-LDPE | 0.1804 (measured) |
| Resin C, tubular-LDPE | 0.1247 (measured) |
| Resin D, autoclave-LDPE | 0.0656 (measured) |
| Resin E, autoclave-LDPE | 0.0689 (measured) |
| Resin F, autoclave-LDPE | 0.0984 (measured) |
| Blend 1, 90 wt % A + 10 wt % G | 0.1143 (calc.) |
| Blend 2, 80 wt % A + 20 wt % G | 0.0588 (calc.) |
| Blend 3, 90 wt % A + 10 wt % H | 0.0852 (calc.) |
| Blend 4, 80 wt % A + 20 wt % H | 0.016 (calc.) |

A person skilled in the art will recognize, that by adding a high molecular weight HDPE to a LDPE made in a tubular reactor, the tubular LDPE can be made to have a neck-in index which is similar to or even better than the neck-in index of a LDPE made in an autoclave reactor. Hence, by adding small amounts (10 or 20 wt %) of a high molecular weight HDPE to the LDPE made in the tubular reactor, with respect to neck-in, it is made to behave more like a LDPE made in an autoclave reactor which is known for its superior neck-in properties.

When considered together, the above data show that a tubular LDPE resin, when combined with a small amount of high molecular weight HDPE, would have improved drawdown rate relative to a tubular-LDPE on its own, and further, that neck-in values would be reduced, giving neck-in values more in line with those observed for autoclave-LDPE. These features are highly desirable for extrusion coating compositions.

What is claimed is:

1. An extrusion coating composition comprising about 95 to about 75 weight percent (based on the weight of the composition) of a high pressure low density polyethylene produced in a tubular reactor and having a melt index I₂ of from about 2 to about 10 g/10 min; and about 25 to about 5 weight percent (based on the weight of the composition) of a high density polyethylene having a melt index I₂ of from greater than 0.1 g/10 min. to less than 1 g/10 min.; wherein the extrusion coating composition has a density of from about 0.918 to about 0.932 g/cm³ and an entanglement density which is at least 10% higher than the entanglement density of the high pressure low density polyethylene produced in a tubular reactor; wherein melt index is measured according to ASTM D-1238 (using a 2.16 kg weight at 190° C.) and density is measured according to ASTM D-792.

2. The extrusion coating composition of claim 1 wherein the high pressure low density polyethylene produced in a tubular reactor has a density of from 0.914 to 0.930 g/cm³.

3. The extrusion coating composition of claim 1 wherein the high pressure low density polyethylene produced in a tubular reactor has a M_{w}/Mₙ of at least 8.0.

4. The extrusion coating composition of claim 1 wherein the high pressure low density polyethylene produced in a tubular reactor has a melt index I₂ of from greater than 3 g/10 min. to 9 g/10 min.

5. The extrusion coating composition of claim 1 wherein the high density polyethylene has a density of greater than 0.940 g/cm³ to 0.950 g/cm³.

6. The extrusion coating composition of claim 1 wherein the high density polyethylene has a melt index I₂ of from greater than 0.1 g/10 min. to 0.7 g/10 min.

7. The extrusion coating composition of claim 1 wherein the high density polyethylene has a melt index I₂ of from 0.2 to 0.5 g/10 min.

8. The extrusion coating composition of claim 1 having a polydispersity index M_{w}/Mₙ of from about 6 to about 10.

9. The extrusion coating composition of claim 1 having a density of from about 0.920 to about 0.932 g/cm³.

10. The extrusion coating composition of claim 1 wherein the high density polyethylene is made with a Ziegler-Natta catalyst or a chromium catalyst in a single reactor.

11. The extrusion coating composition of claim 1 wherein the high density polyethylene has a broad, unimodal profile when analyzed by gel permeation chromatography.

12. An extrusion coating process characterized in that said process comprises coating a substrate with a polymer blend comprising: about 95 to about 75 weight percent, based on the weight of the blend, of a high pressure low density polyethylene produced in a tubular reactor; and about 25 to about 5 weight percent, based on the weight of the blend, of a high density polyethylene having a melt index I₂ of less than 1 g/10 min.; wherein the polymer blend has a density of from about 0.918 to about 0.932 g/cm³ and an entanglement density which is at least 10% higher than the entanglement density of the high pressure low density polyethylene produced in a tubular reactor; wherein melt index is measured according to ASTM D-1238 (using a 2.16 kg weight at 190° C.) and density is measured according to ASTM D-792.

13. The extrusion coating process of claim 12 wherein the high pressure low density polyethylene produced in a tubular reactor has a density of from 0.914 to 0.930 g/cm³.

14. The extrusion coating process of claim 12 wherein the high pressure low density polyethylene produced in a tubular reactor has a M_{w}/Mₙ of at least 8.0.

15. The extrusion coating process of claim 12 wherein the high pressure low density polyethylene produced in a tubular reactor has a melt index I₂ of from greater than 3 g/10 min. to 9 g/10 min.

16. The extrusion coating process of claim 12 wherein the high density polyethylene has a density of greater than 0.940 g/cm³ to 0.950 g/cm³.

17. The extrusion coating process of claim 12 wherein the high density polyethylene has a melt index I₂ of from greater than 0.1 g/10 min. to 0.7 g/10 min.

18. The extrusion coating process of claim 12 wherein the high density polyethylene has a melt index I₂ of from 0.2 to 0.5 g/10 min.

19. The extrusion coating process of claim 12 wherein the blend has a polydispersity index M_{w}/Mₙ of from about 6 to about 10.

20. The extrusion coating process of claim 12 wherein the blend has a density of from about 0.920 to about 0.932 g/cm³

21. The extrusion coating process of claim 12 wherein the high density polyethylene is made with a Ziegler-Natta catalyst or a chromium catalyst in a single reactor.

22. The extrusion coating process of claim 12 wherein the high density polyethylene has a broad, unimodal profile when analyzed by gel permeation chromatography.
